(19) United States
(12) Patent Application Publication
(10) Pub. No.: US 2023/0359841 A1
(43) Pub. Date: Nov. 9, 2023

(54) STORE SYSTEM, STORE APPARATUS, CHECKOUT METHOD, AND PROGRAM

(71) Applicant: NEC Corporation, Tokyo (JP)

(72) Inventors: Kazuki MIURA, Tokyo (JP); Maya TAKABATAKE, Tokyo (JP)

(73) Assignee: NEC Corporation, Tokyo (JP)

(21) Appl. No.: 18/222,956

(22) Filed: Jul. 17, 2023

Related U.S. Application Data
(63) Continuation of application No. 17/435,491, filed on Sep. 1, 2021.

(30) Foreign Application Priority Data
Mar. 4, 2019 (JP) 2019-038666

(51) Int. Cl. G06K 7/10; G07C 9/28; G07C 9/25; G06V 40/16; G06Q 20/20; G07C 9/00; G07G 1/00; G07G 1/12

(52) U.S. Cl. CPC G06K 7/10445; G07C 9/28; G07C 9/257; G06V 40/166; G06K 7/10297; G06Q 20/208; G06Q 20/209; G07C 9/00658; G07G 1/0009; G07G 1/12

(57) ABSTRACT

A store system (1) includes: a reading apparatus (220) that reads a product that passes through a gate (20); a person determination information acquisition apparatus (210) that acquires person determination information that determines a person P who passes through the gate (20); a coupon notification unit (110) that transmits, when a coupon applicable to any product read by the reading apparatus (220) is present, notification information that provides notification of the applicable coupon, to a terminal (30) associated with the person determination information; a checkout unit (120) that performs checkout processing of a product read by the reading apparatus (220), and application processing of a coupon based on coupon use information that is acquired from the terminal (30) and indicates a coupon to be used by the person P; and an electronic receipt transmission unit (130) that transmits an electronic receipt to the terminal (30) in response to execution of the checkout processing and the application processing of a coupon.

This application is a Continuation of U.S. application Ser. No. 17/435,491 filed on Sep. 1, 2021, which is a National Stage Entry of PCT/JP2020/005124 filed on Feb. 10, 2020, which claims priority from Japanese Patent Application 2019-038666 filed on Mar. 4, 2019, the contents of all of which are incorporated herein by reference, in their entirety.

### TECHNICAL FIELD

The present invention relates to a technique for assisting with accounting processing at a store.

### BACKGROUND ART

There is a technique for shortening time of accounting processing at a store by reading a product that passes through a gate. For example, PTL 1 described below discloses a technique for reading, by an antenna provided at a gate, a wireless tag provided to a product put in a cart, and performing checkout of the product, based on data of the read wireless tag.

### CITATION LIST

### Patent Literature

[PTL 1] Japanese Patent Application Publication No. 2010-267011

### SUMMARY OF INVENTION

### Technical Problem

In a system for reading a product that passes through a gate and performing checkout, when a customer has a price fluctuation element (for example, various coupons issued as a physical or electronic medium, and the like), there is a risk that speed of checkout processing of a computer may decrease.

The present invention has been made in view of the above-described problem. One of objects of the present invention is to provide a technique for suppressing a decrease in speed of checkout processing of a computer when a customer has a price fluctuation element in a system for reading a product that passes through a gate and performing checkout.

### Solution to Problem

A store system according to the present invention, including:
a reading unit that reads a product that passes through a gate;
a person determination information acquisition unit that acquires person determination information that determines a person who passes through the gate;
a coupon notification unit that transmits, when a coupon applicable to any product read by the reading unit is present, notification information that provides notification of the applicable coupon, to a terminal associated with the person determination information;
a checkout unit that performs checkout processing of a product read by the reading unit, and application processing of a coupon based on coupon use information that is acquired from the terminal and indicates a coupon to be used by the person; and
an electronic receipt transmission unit that transmits an electronic receipt to the terminal in response to execution of the checkout processing and the application processing of a coupon.

A checkout method according to the present invention is a checkout method being executed by at least one computer, and includes:
reading a product that passes through a gate;
acquiring person determination information that determines a person who passes through the gate;
transmitting, when a coupon applicable to any read product is present, notification information that provides notification of the applicable coupon, to a terminal associated with the person determination information;
performing checkout processing of the read product, and application processing of a coupon based on coupon use information that is acquired from the terminal and indicates a coupon to be used by the person; and
transmitting an electronic receipt to the terminal in response to execution of the checkout processing and the application processing of a coupon.

A program according to the present invention causing at least one computer to function as:
a reading unit that reads a product that passes through a gate;
a person determination information acquisition unit that acquires person determination information that determines a person who passes through the gate;
a coupon notification unit that transmits, when a coupon applicable to any product read by the reading unit is present, notification information that provides notification of the applicable coupon, to a terminal associated with the person determination information;
a checkout unit that performs checkout processing of a product read by the reading unit, and application processing of a coupon based on coupon use information that is acquired from the terminal and indicates a coupon to be used by the person; and
an electronic receipt transmission unit that transmits an electronic receipt to the terminal in response to execution of the checkout processing and the application processing of a coupon.

A store apparatus according to the present invention, including:
a person determination information reception unit that receives person determination information that determines a user who passes through a gate;
a coupon notification unit that transmits, when a coupon applicable to any read product is present, coupon information about the applicable coupon to a terminal of the user determined by the person determination information; and
a checkout unit that performs, when coupon information indicating a coupon being selected by the user is received from the terminal, checkout processing of the read product, based on the coupon information.

A second checkout method according to the present invention, including:
by a computer,
receiving person determination information that determines a user who passes through a gate;
transmitting, when a coupon applicable to any read product is present, coupon information about the applicable coupon to a terminal of the user determined by the person determination information; and
performing, when coupon information indicating a coupon being selected by the user is received from the terminal, checkout processing of the read product, based on the coupon information.

A second program according to the present invention causing a computer to function as:
a person determination information reception unit that receives person determination information that determines a user who passes through a gate;
a coupon notification unit that transmits, when a coupon applicable to any read product is present, coupon information about the applicable coupon to a terminal of the user determined by the person determination information; and
a checkout unit that performs, when coupon information indicating a coupon being selected by the user is received from the terminal, checkout processing of the read product, based on the coupon information.

A third program according to the present invention causing a computer to function as:
a coupon information notification unit that acquires notification information indicating a coupon applicable to a product being read at a gate, and displaying a screen including information about the applicable coupon;
a coupon use declaration reception unit that receives, on the screen, a use declaration of a coupon; and
a coupon use information transmission unit that transmits, in response to the use declaration of a coupon, coupon use information indicating a coupon to be used to a store apparatus that performs checkout processing.

### Advantageous Effects of Invention

According to the present invention, a decrease in speed of checkout processing of a computer can be suppressed when a customer has a price fluctuation element in a system for reading a product that passes through a gate and performing checkout.

### BRIEF DESCRIPTION OF DRAWINGS

The above-described object, the other objects, features, and advantages will become more apparent from suitable example embodiments described below and the following accompanying drawings.

FIG. 1 is a diagram illustrating a configuration of a store system according to a first example embodiment.

FIG. 2 is a block diagram illustrating a hardware configuration of a store apparatus.

FIG. 3 is a flowchart illustrating a flow of processing performed by the store system according to the first example embodiment.

FIG. 4 is one example of information that defines a correspondence between a product and an RF tag.

FIG. 5 is a diagram illustrating a state in a storage region after a person P passes through a gate.

FIG. 6 is a diagram illustrating one example of information that manages a coupon possessed by each person.

FIG. 7 is a diagram illustrating one example of information indicating a content of each coupon.

FIG. 8 is a diagram illustrating a flow of selecting a coupon to be used in a terminal.

FIG. 9 is a diagram illustrating a configuration of a store system according to a second example embodiment.

FIG. 10 is a diagram illustrating one example of information that guides a customer to a place where the customer can receive service.

FIG. 11 is a diagram illustrating a functional configuration of an application program.

FIG. 12 is a flowchart illustrating a flow of processing performed by the application program.

### EXAMPLE EMBODIMENT

Hereinafter, example embodiments of the present invention will be described by using drawings. Note that, in all of the drawings, a similar component has a similar reference sign, and description thereof will be appropriately omitted. Further, in each block diagram, each block represents a configuration of a functional unit instead of a configuration of a hardware unit unless otherwise described. Furthermore, a direction of an arrow in the drawings is used for facilitating understanding of a flow of information, and does not limit a direction (one-way communication/two-way communication) of communication unless otherwise described.

### First Example Embodiment

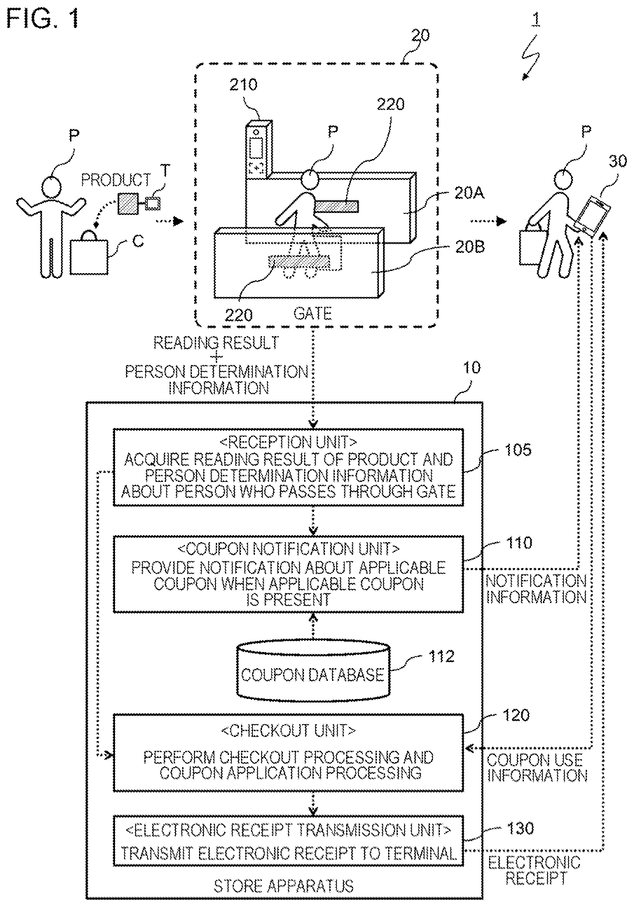

FIG. 1 is a diagram illustrating a configuration of a store system 1 according to a first example embodiment. As illustrated in FIG. 1, the store system 1 is configured to include a store apparatus 10 and a gate 20.

As described above, in a system for reading a product that passes through a gate and performing checkout, when a customer has a price fluctuation element (for example, various coupons issued as a physical or electronic medium, and the like), there is a risk that speed of checkout processing of a computer may decrease. The problem is solved by one example of a checkout unit included in the store system according to the present example embodiment described later.

Further, as exemplified in PTL 1, for example, in a system for reading a product that passes through a gate and performing checkout, even when a customer has a price fluctuation element (for example, various coupons issued as a physical or electronic medium, and the like), there is another problem that a coupon cannot be used. The problem is solved by each functional configuration unit of the store system according to the present example embodiment described later.

### <Flow of Basic Checkout Processing>

In the store system 1 illustrated in FIG. 1, checkout processing having a flow as follows is performed.

First, a person P (customer) who comes to a store puts a product to be purchased in a container C (such as a shopping bag, a basket, or a cart). Herein, a radio frequency (RF) tag T for radio frequency identification (RFID) is provided to an individual product. The RF tag T is also referred to as an integrated circuit (IC) tag and an electronic tag. The RF tag T may be a passive tag, and may be an active tag. For example, a passive RF tag acquires operating power by receiving a radio wave from a reading apparatus 220, codes information in the RF tag, and sends the coded information to the reading apparatus 220. Further, an active RF tag codes information in the RF tag with a built-in power supply as electric power, and sends the coded information to the reading apparatus 220. Herein, the RF tag T stores identification information unique to an individual. A plurality of products of the same type (two or more products having the same product identification information such as a Japan article number (JAN) code) can be individually recognized by using the RF tag T.

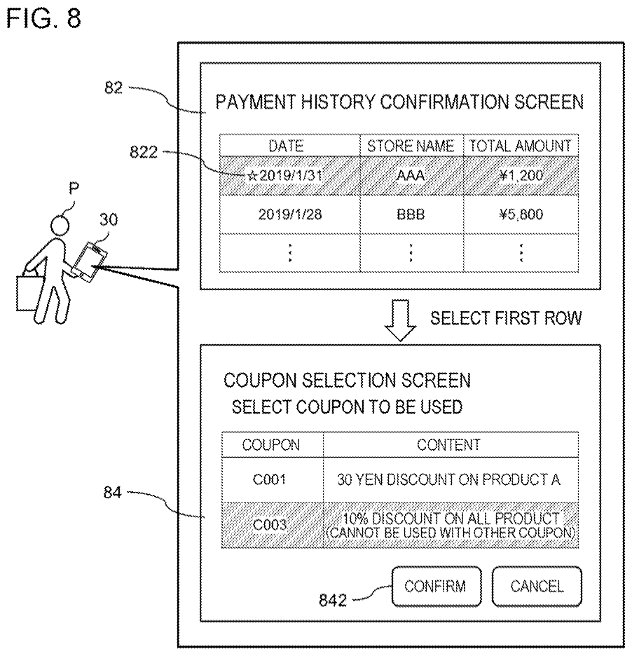

Before coming to a store, a person P installs a special application in a terminal 30 of the person P, and completes initial setting. For example, personal information about the person P and a face image of the person P are registered. The registered personal information includes, for example, a name, an address, a phone number, and a payment method (such as a credit card number, a debit card number, an electronic money checkout type, and an account number for automatic direct debit). Note that, a face image of the person P may be registered by capturing in a special terminal at a store. The person P who visits a store puts a product to be purchased in the container C, and then passes through the gate 20 with the container C. When the person P passes through the gate 20, an RF tag T provided to the product in the container C is read, and a purchase product of the customer is recognized in the store system 1. Subsequently, payment processing of a price of a product recognized in the store system 1 is performed by using information (such as information about a credit card and information about a direct debit account) about a payment unit associated with the person P. Subsequently, an electronic receipt including information about a purchase product, information about a payment price, and the like is transmitted to the terminal 30 possessed by the person P. When the terminal 30 receives the electronic receipt, the terminal 30 notifies, by sound, vibration, screen display, and the like, that the electronic receipt is received. When a response (for example, a touch on display on a screen, and the like) is made to the notification on the terminal 30, for example, a screen as illustrated in FIG. 8 described later is displayed on the terminal 30. The person P can view the electronic receipt indicating a content of checkout processing by operating the screen.

### <Functional Configuration of Gate 20>

The gate 20 includes a person determination information acquisition apparatus 210 (person determination information acquisition unit) that acquires information (hereinafter, also expressed as “person determination information”) for determining a person P who passes through the gate 20, and the reading apparatus 220 (reading unit) that reads a product that passes through the gate 20.

As one example, the person determination information acquisition apparatus 210 is configured to include a camera module. In this case, the person determination information acquisition apparatus 210 is installed in a state where a position and an orientation are adjusted in such a way as to be able to generate an image (hereinafter, also expressed as a “face image”) including a face of a person P (customer) who enters the gate 20. The person determination information acquisition apparatus 210 acquires a face image generated by the camera module as person determination information. The face image is used for face authentication processing of a person who passes through the gate 20. In the face authentication processing, whether a person is registered in advance is determined by performing matching for a face image of a person (for example, a member of a store, and the like) registered in advance. Note that, the face authentication processing may be performed by the person determination information acquisition apparatus 210, and may be performed by a not-illustrated server apparatus.

As another example, the person determination information acquisition apparatus 210 is configured to include a card reader module that reads a card (for example, a credit card, an electronic money card, a store member card, and the like) including information that can uniquely determine a person (customer). In this case, the person determination information acquisition apparatus 210 acquires person determination information stored in each card via the card reader module. Then, processing of verifying person determination information acquired by the person determination information acquisition apparatus 210 with information (card information) about each person registered in advance, and authenticating an individual is performed. Note that, the authentication processing may be performed by the person determination information acquisition apparatus 210, and may be performed by a not-illustrated server apparatus.

As another example, the person determination information acquisition apparatus 210 is configured to include a code reader module that reads a code symbol (a one-dimensional code and a two-dimensional code) in which information that can uniquely determine a person (customer) is encoded. In this case, the person determination information acquisition apparatus 210 acquires, by an application installed in a portable terminal such as a smartphone, for example, person determination information from a code symbol displayed on a screen of the portable terminal or a code symbol printed on a medium such as paper. Then, processing of verifying person determination information acquired by the person determination information acquisition apparatus 210 with information (for example, a user ID issued at a time of application installation, and the like) about each person registered in advance, and authenticating an individual is performed. Note that, the authentication processing may be performed by the person determination information acquisition apparatus 210, and may be performed by a not-illustrated server apparatus.

When the authentication processing using the person determination information described above is successful, the authenticated person is permitted to pass through the gate 20. For example, when the authentication processing is successful, a not-illustrated door on an entrance side of the gate 20 is open. In addition, when a not-illustrated notification apparatus (such as a speaker, a display, and a lamp) is provided on the gate 20, and the authentication processing is successful, the notification apparatus may be configured to aurally or visually provide notification of permission of passage.

Note that, the person determination information acquisition apparatus 210 may be configured in such a way as to include a combination of a plurality of modules exemplified herein. Further, although not illustrated, the person determination information acquisition apparatus 210 may be provided as a single apparatus separated from the gate 20 in a position different from the gate 20. For example, the person determination information acquisition apparatus 210 may be provided in a position (for example, a region between an entrance of the gate 20 and a waiting place, and the like) slightly away from the gate 20, an entrance of a store, and the like.

As a specific example, a case where the person determination information acquisition apparatus 210 including the camera module is provided at an entrance of a store is considered. In this case, the person determination information acquisition apparatus 210 can acquire person determination information about a person captured in an image generated by the camera module, by performing face authentication and the like by using the image. Further, in this case, the store apparatus 10 can recognize a correspondence between a reading result of a product and the person determination information by comparing timing (time) at which the person who comes near the gate 20 with timing (time) at which a product is read in the reading apparatus 220. Note that, timing at which a person comes near the gate 20 is recognized by tracking the person by using an image of a camera installed in a store. For example, the store apparatus 10 tracks a recognized person by using a known algorithm that generates a path of flow of a person, and can determine that the “person comes near the gate 20” when a difference between a terminal (current position) of the path of flow of the person and a reference position (for example, a position of an entrance) of the gate 20 becomes less than a predetermined threshold value.

In the example in FIG. 1, the reading apparatus 220 is configured to read an RF tag provided to an individual product put in the container C when the person P passes through the gate 20. The reading apparatus 220 is provided on side wall portions (portions indicated by reference signs 20A and 20B in the drawing) of the gate 20. Note that, the side wall portions 20A and 20B of the gate 20 are provided at a width through which the container C and a person can pass at the same time. The reading apparatus 220 communicates with the RF tag T provided to each product, and acquires information stored in a storage region (not illustrated) of each RF tag T.

Herein, at least identification information (tag ID) unique to an individual is stored in the storage region of the RF tag T. Information related to a product provided with the RF tag T may be further stored in the storage region of the RF tag T. Tag recording information (tag ID, or information including a tag ID and product information) stored in the storage region of the RF tag T is transported by a radio wave emitted from the RF tag T.

Although not illustrated in FIG. 1, a plurality of the gates 20 may be provided side by side. When the plurality of gates 20 are provided side by side, a not-illustrated radio wave shield member (for example, an aluminum sheet, and the like) is preferably disposed outside the side wall portions 20A and 20B of each of the gates 20. For example, the following effect can be acquired by the radio wave shield member disposed outside the side wall portions 20A and 20B. In other words, an effect of reducing a possibility that, when a certain person passes through the gate 20, another adjacent gate 20 receives, by mistake, a radio wave of the RF tag T provided to a product to be purchased by the person can be acquired.

Note that, a configuration of the gate 20 is not limited to the example in FIG. 1. For example, the reading apparatus 220 may be incorporated as a part of the gate 20 into the gate 20, and may be provided as a single apparatus separated from the gate 20. Further, for example, the reading apparatus 220 may be configured to acquire an image of a product put in the container C when a person passes through the gate 20, and read the product by processing the image. In this case, an RF tag may not be provided to an individual product.

### <Functional Configuration of Store Apparatus 10>

As illustrated in FIG. 1, the store apparatus 10 according to the present example embodiment includes a reception unit 105, a coupon notification unit 110, a checkout unit 120, and an electronic receipt transmission unit 130.

The reception unit 105 receives a reading result of a product by the reading apparatus 220 together with person determination information (information that determines the person P who passes through the gate 20) acquired by the person determination information acquisition apparatus 210. The coupon notification unit 110 provides notification of information indicating an applicable coupon to the terminal 30 possessed by the person P who passes through the gate 20. Specifically, the coupon notification unit 110 operates as follows. First, the coupon notification unit 110 reads, from a coupon database 112 that stores a usable coupon for each person, information about a coupon associated with person determination information about the person P acquired by the person determination information acquisition apparatus 210. Note that, the coupon database 112 may be provided in another external apparatus (not illustrated) communicably connected via a network. Then, the coupon notification unit 110 determines whether a coupon applicable to any product read by the reading apparatus 220 is present in the read coupon. When an applicable coupon is present, the coupon notification unit 110 transmits notification information to the terminal 30 associated with the person determination information about the person P.

Herein, the notification information is information that provides notification of an applicable coupon described above. For example, the notification information is information for displaying, on the terminal 30, a screen for selecting whether to use an applicable coupon. When the person P uses an applicable coupon, the person P performs, on the screen displayed on the terminal 30, a use declaration operation (for example, operation of selecting a coupon to be used) indicating an intention to use a coupon. When the person P performs the use declaration operation on the terminal 30, information (hereinafter, also expressed as “coupon use information”) indicating a coupon to be used by the person P is transmitted from the terminal 30 to the store apparatus 10. The coupon use information includes at least information (for example, identification information assigned to each coupon, and the like) for identifying a coupon to be used by the person P.

The checkout unit 120 performs checkout processing of a product read by the reading apparatus 220, and application processing of a coupon indicated by coupon use information. Note that, when the checkout unit 120 acquires coupon use information from the terminal 30, the checkout unit 120 performs the application processing of a coupon, based on the coupon use information.

The electronic receipt transmission unit 130 transmits an electronic receipt to the terminal 30 in response to execution of the checkout processing and the coupon application processing. For example, the electronic receipt transmission unit 130 generates electronic receipt data including a content such as a name and a price of a product as a target of the checkout processing, and transmits the electronic receipt data to the terminal 30. Herein, when the coupon application processing is performed on any coupon, the electronic receipt transmission unit 130 generates an electronic receipt reflecting a content of the coupon. Then, the electronic receipt transmission unit 130 can transmit the electronic receipt data to the terminal 30 by using destination information of the terminal 30 previously associated with the person determination information. Further, the electronic receipt transmission unit 130 may be configured in such a way as to store, in a not-illustrated server apparatus, the generated electronic receipt data in association with the person determination information acquired in the checkout processing. In this case, a customer can confirm an electronic receipt by accessing the not-illustrated server apparatus and downloading the electronic receipt data into the terminal 30.

As described above, in the present example embodiment, in a system for reading a product that passes through the gate 20 and performing checkout processing on the product, when there is a coupon applicable to any read product, notification information about the coupon is transmitted to the terminal 30 of a person who purchases the product. Then, when coupon use information indicating use of the coupon is transmitted from the terminal 30, application processing of a coupon associated with the coupon use information is performed.

In the system for reading a product that passes through the gate 20 and performing checkout processing on the product, with a technique exemplified in PTL 1, a customer cannot use a usable coupon when the customer has the coupon. According to the configuration of the present example embodiment described above, in the system for reading a product that passes through the gate 20 and performing checkout processing on the product, a customer can use a coupon.

### <Hardware Configuration Example of Store Apparatus 10>

The store system 10 may be achieved by hardware (for example: a hard-wired electronic circuit, and the like) that achieves each functional component unit, and may be achieved by a combination of hardware and software (for example: a combination of an electronic circuit and a program that controls the electronic circuit, and the like). Hereinafter, a case where the store apparatus 10 is achieved by the combination of hardware and software will be further described.

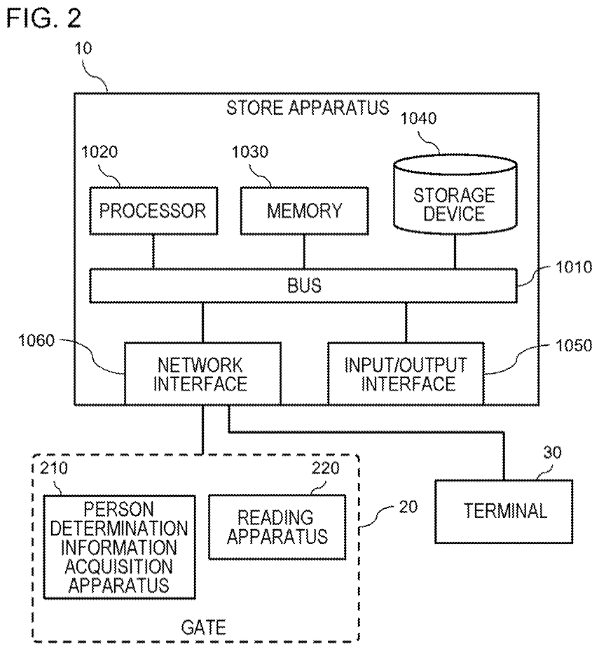

FIG. 2 is a block diagram illustrating a hardware configuration of the store apparatus 10.

The store apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (such as the reception unit 105, the coupon notification unit 110, the checkout unit 120, and the electronic receipt transmission unit 130) of the store apparatus 10. The processor 1020 reads each program module onto the memory 1030 and executes each program module, and thereby each function associated with each program module is achieved.

The input/output interface 1050 is an interface for connecting the store apparatus 10 to a not-illustrated peripheral apparatus. The peripheral apparatus includes, for example, an input apparatus such as a keyboard and a mouse, and an output apparatus such as a display (touch panel display) and a speaker. Note that, an input apparatus and an output apparatus as described above may not be connected to the input/output interface 1050.

The network interface 1060 is an interface for connecting the store device 10 to a network. The network is, for example, a local area network (LAN) and a wide area network (WAN). A method of connection to the network by the network interface 1060 may be wireless connection or wired connection. The store apparatus 10 is communicably connected to an external apparatus such as the person determination information acquisition apparatus 210 and the reading apparatus 220 of the gate 20, and the terminal 30 via the network interface 1060.

Although not illustrated, the person determination information acquisition apparatus 210 and the reading apparatus 220 also include a processor, a memory, a storage device, an input/output interface, a network interface, and the like similarly to the store apparatus 10. The storage device of the person determination information acquisition apparatus 210 stores a program module that achieves a function of acquiring person determination information. The processor of the person determination information acquisition apparatus 210 achieves the function of acquiring person determination information by reading the program module onto the memory and executing the program module. Further, the storage device of the reading apparatus 220 stores a program module that achieves a function of reading a product (function of recognizing a product, based on information read from an RF tag). The processor of the reading apparatus 220 achieves the function of reading a product (function of recognizing a product, based on information read from an RF tag) by reading the program module onto the memory and executing the program module.

Herein, a functional unit that recognizes a product, based on information read from an RF tag, may be provided in the store apparatus 10. In this case, the reading apparatus 220 reads information (tag ID) stored in the RF tag, and transmits the information to the store apparatus 10. Then, the store apparatus 10 refers to information indicating a correspondence between an individual product and the RF tag, based on the tag ID acquired from the reading apparatus 220, and acquires information about the product associated with the tag ID.

Note that, the configuration illustrated in FIG. 2 is merely one example, and a configuration of hardware including the store apparatus 10 is not limited to the example in FIG. 2.

### <Flow of Processing>

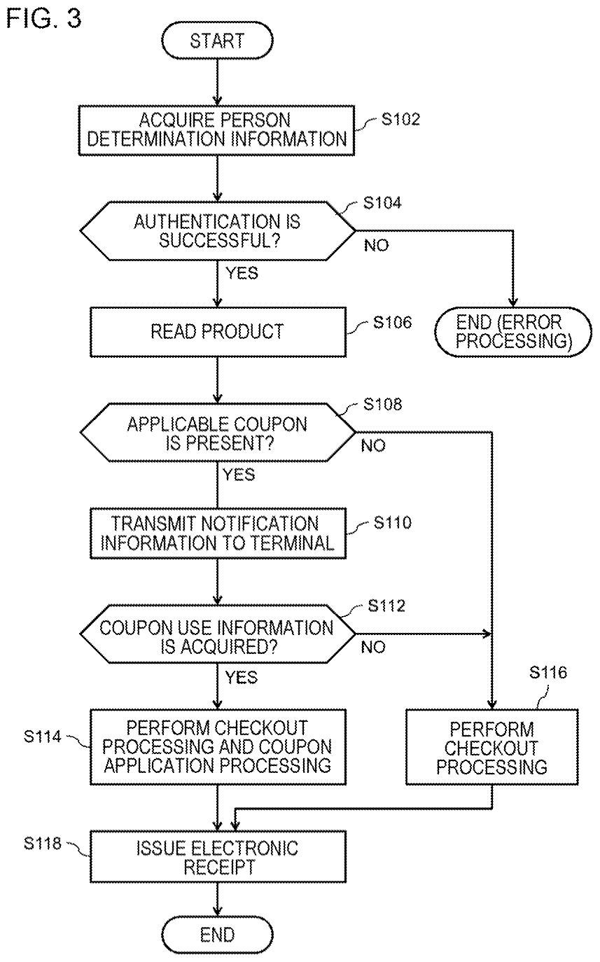

By using FIG. 3, a flow of processing performed by the store system 1 according to the present example embodiment will be described. FIG. 3 is a flowchart illustrating the flow of the processing performed by the store system 1 according to the first example embodiment.

First, the person determination information acquisition apparatus 210 acquires person determination information (S102). Then, the person determination information acquisition apparatus 210 performs, by using the acquired person determination information, personal authentication processing of determining whether a person who is about to pass through the gate is a person registered in advance (S104). For example, the person determination information acquisition apparatus 210 acquires a face image of a person who passes through the gate 20 being generated by a camera module, and performs face authentication processing using the face image. When the authentication of the person who passes through the gate 20 is successful, the person determination information acquisition apparatus 210 transmits the person determination information about the person to the store apparatus 10. The person determination information transmitted from the person determination information acquisition apparatus 210 is received by the reception unit 105.

When the person determination information acquisition apparatus 210 includes a camera module that generates a face image for face authentication processing, the person determination information acquisition apparatus 210 may have a function as follows. In other words, the person determination information acquisition apparatus 210 may have a function of causing the camera module to perform a capturing operation in response to detection of a person by an entering person detection sensor that detects a person (person who enters the gate 20) located in front of the gate 20. In this way, an effect of reducing a possibility that a person who does not enter the gate 20 is authenticated by mistake is expected.

When the authentication is not successful in the personal authentication processing (S104: NO), the person determination information acquisition apparatus 210 outputs predetermined error processing. For example, the person determination information acquisition apparatus 210 performs processing of outputting an error sound from a not-illustrated speaker apparatus, processing of closing a door provided at an entrance of the gate 20 and hindering entry into the gate 20, and the like. Note that, when the error processing is performed, processing described below is not performed.

When the authentication is successful in the personal authentication processing (S104: YES), the authenticated person can enter the gate 20. The person passes through the gate 20, and thus a product is read by the reading apparatus 220 (S106). Herein, “reading of a product” includes not only acquisition of product information (information including identification information, a name, a price, and the like about a product), but also reading of information (for example, a tag ID stored in an RF tag provided to an individual product, and the like) associated with product information.

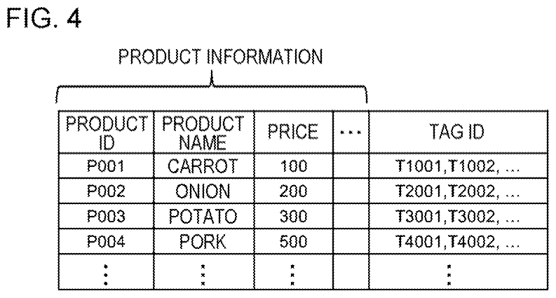

As one example, after the reading apparatus 220 reads information stored in an RF tag, the reading apparatus 220 transmits the read information to the store apparatus 10. Then, the store apparatus 10 acquires, by using information as illustrated in FIG. 4, product information associated with a tag ID of the information. FIG. 4 is one example of information that defines a correspondence between a product and an RF tag. The information illustrated in FIG. 4 is stored in advance in a storage region such as the memory 1030 and the storage device 1040, for example. As a specific example, when the reading apparatus 220 reads information being “T1001” from a certain RF tag, and the information is transmitted to the store apparatus 10, the store apparatus 10 can acquire product information related to a “product A”, based on the information acquired from the reading apparatus 220. As another example, when product information is stored in a storage region of an RF tag, the reading apparatus 220 reads the product information from the RF tag and transmits a reading result to the store apparatus 10. Person determination information transmitted from the reading apparatus 220 is received by the reception unit 105.

Then, the coupon notification unit 110 determines whether a coupon applicable to any read product is present (S108). When an applicable coupon is not present (S108: NO), the checkout unit 120 performs checkout processing (S116). At this time, the checkout unit 120 does not perform coupon application processing. On the other hand, when an applicable coupon is present (S108: YES), the coupon notification unit 110 generates notification information that provides notification of the applicable coupon. Then, the coupon notification unit 110 transmits the generated notification information to the terminal 30 associated with the person determination information acquired in the processing in S102 (S110).

When the notification information that provides notification of the applicable coupon is transmitted to the terminal 30, and then coupon use information indicating a coupon to be used is not acquired from the terminal 30 (S112: NO), the checkout unit 120 performs the checkout processing (S116). At this time, the checkout unit 120 does not perform the coupon application processing. On the other hand, when the notification information that provides notification of the applicable coupon is transmitted to the terminal 30, and then coupon use information indicating a coupon to be used is acquired from the terminal 30 (S112: YES), the checkout unit 120 performs the checkout processing and the coupon application processing (S114). Herein, the checkout unit 120 may first perform and complete the checkout processing, and then perform the coupon application processing (correct a result of the checkout processing being once confirmed) in response to acquisition of the coupon use information, or the checkout unit 120 may perform the application processing of a coupon and then perform the checkout processing.

Then, the electronic receipt transmission unit 130 issues an electronic receipt in response to execution of the checkout processing (or, the checkout processing and the coupon application processing) (S118). For example, the electronic receipt transmission unit 130 transmits, to the terminal 30 possessed by a first person, data about an electronic receipt generated based on a result of the checkout processing. Further, the electronic receipt transmission unit 130 may transmit, to a not-illustrated server apparatus, data about an electronic receipt generated based on a result of the checkout processing, in association with person determination information about the first person. In the latter case, for example, the person determination information about the first person is transmitted to the server apparatus via an application installed in the terminal 30, and the like, and thus electronic receipt data associated with the person determination information are transmitted from the server apparatus to the terminal 30.

### <Specific Example of Processing>

Hereinafter, processing performed by the store system 1 according to the present example embodiment will be described with a specific example.

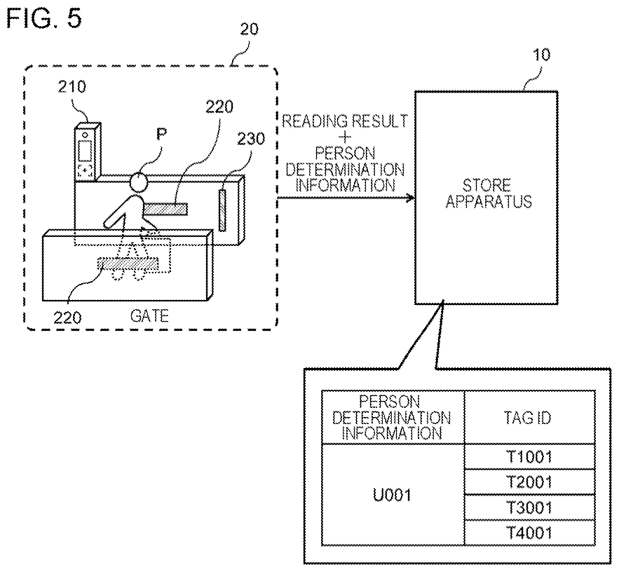

First, a person P who succeeds in personal authentication processing passes through the gate 20, and thus information related to the person P is registered in a predetermined storage region such as the memory 1030 and the storage device 1040 of the store apparatus 10 (for example: FIG. 5). FIG. 5 is a diagram illustrating a state in a storage region after the person P passes through the gate 20. According to FIG. 5, it is clear that, when the person P passes through the gate 20, the person determination information acquisition apparatus 210 acquires person determination information being “U001”. Further, it is clear that, when the person P passes through the gate 20, the reading apparatus 220 reads four tags (i.e., four products) individually identified by a tag ID “T1001”, a tag ID “T2001”, a tag ID “T3001”, and a tag ID “T4001”. The information is transmitted to the store apparatus 10.

Further, the coupon notification unit 110 recognizes a product read at the gate 20 by using the information as illustrated in FIG. 4. In this case, the coupon notification unit 110 recognizes four products (carrot, onion, potato, and pork). Then, the coupon notification unit 110 determines whether a coupon applicable to any product being read when the person P passes through the gate 20 is present.

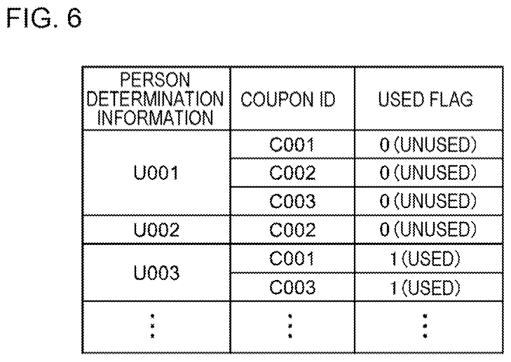

First, the coupon notification unit 110 determines a coupon possessed by each person by referring to information as illustrated in FIG. 6. FIG. 6 is a diagram illustrating one example of information that manages a coupon possessed by each person. Note that, the information as illustrated in FIG. 6 is stored in the coupon DB 112, for example. In the example in FIG. 6, information about a coupon is associated with person determination information about each person. According to the information in FIG. 6, it is clear that, for example, a person determined by person determination information “U001” possesses unused coupons identified by coupon IDs “C001”, “C002”, and “C003”.

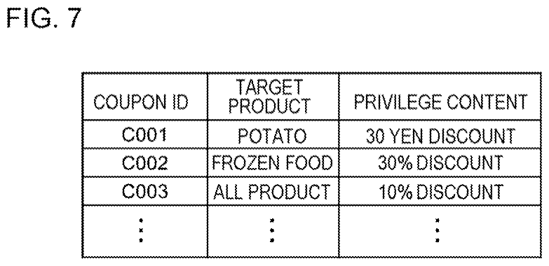

Further, the coupon notification unit 110 determines a product as a target of each coupon by referring to information as illustrated in FIG. 7, for example. FIG. 7 is a diagram illustrating one example of information indicating a content of each coupon. Note that, the information as illustrated in FIG. 7 is stored in the coupon DB 112, for example. According to the information in FIG. 7, it is clear that the coupons identified by the coupon IDs “C001”, “C002”, and “C003” are targeted for “potato”, “frozen food”, and “all product”, respectively.

Herein, the coupon notification unit 110 recognizes the four products including “potato” as “read products”. Thus, in this case, the coupon notification unit 110 determines that an “applicable coupon is present”. Specifically, the coupon notification unit 110 determines that the coupons identified by the coupon IDs “C001” and “C003” are applicable. When it is determined that an applicable coupon is present, the coupon notification unit 110 transmits notification information to the terminal 30 of the person determined by the person determination information “U001”. Note that, address information about the terminal 30 of each person is previously stored, in the storage device 1040 and the like, in association with person determination information about the person. The notification information is transmitted, to the terminal 30, in form of a push notification of an application, e-mail, and the like, for example.

Note that, in the example in FIG. 5, when acquired person determination information is “U002” or “U003”, the coupon notification unit 110 determines that an “applicable coupon is not present”. Specifically, a person determined that acquired person determination information is “U002” possesses, as an unused coupon, a coupon targeted for “frozen food”. However, frozen food is not present among the products being read this time. Thus, when acquired person determination information is “U002”, the coupon notification unit 110 determines that an “applicable coupon is not present”. Further, a person determined that acquired person determination information is “U003” possesses only a used coupon. Thus, when acquired person determination information is “U003”, the coupon notification unit 110 determines that an “applicable coupon is not present”. In this case, the coupon notification unit 110 does not transmit the notification information. Thus, the checkout unit 120 performs the checkout processing on the read product without performing the coupon application processing. Then, the electronic receipt transmission unit 130 issues electronic receipt data indicating a content of the performed checkout processing.

When the coupon notification unit 110 determines that an “applicable coupon is present” and transmits the notification information to the terminal 30, the person P who receives the notification information can use a desired coupon as illustrated in FIG. 8, for example. However, the example illustrated in FIG. 8 is merely one example, and the present invention is not limited to the example in FIG. 8. FIG. 8 is a diagram illustrating a flow of selecting a coupon to be used in the terminal 30. First, the person P who passes through the gate 20 confirms a history of checkout results via a screen 82 displayed on an application installed in the terminal or a browser. The screen 82 illustrated in FIG. 8 displays a list of past checkout results. Herein, when the notification information is received from the coupon notification unit 110, a predetermined mark 822 (a blank star in the example in FIG. 8) is provided to a row of an associated checkout result. The predetermined mark 822 makes it easier for the person P to notice an applicable coupon. Subsequently, the person P operates the terminal 30, and selects the checkout result (in a first row in the example in FIG. 8) as a target. When the checkout result as a target is selected, a screen 84 for selecting a coupon to be used is displayed as a next screen. On the screen 84, the person P selects a desired coupon (coupon of “C003” in the example in FIG. 8) and presses a confirmation button 842. In response to the press on the confirmation button 842, coupon use information (herein, information indicating use of the coupon of “C003”) is transmitted from the terminal 30 to the store apparatus 10. In response to acquisition of the coupon use information from the terminal 30, the checkout unit 120 performs the application processing of the coupon indicated by the coupon use information. Then, the electronic receipt transmission unit 130 issues electronic receipt data indicating a content of the performed coupon application processing and the checkout processing.

Herein, the checkout unit 120 can first perform and complete the checkout processing, and perform the coupon application processing (correct a result of the checkout processing being once confirmed) in response to acquisition of the coupon use information. For example, the checkout unit 120 may be configured to perform the checkout processing in response to exit of the person P from the gate 20, and complete the checkout processing before the coupon application processing is performed. In this case, the checkout unit 120 can recognize exit of the person P from the gate 20, based on an output of, for example, an exiting person detection sensor (for example: reference sign 230 in FIG. 5) that is provided on an exit side of the gate 20 and detects a person who exits from the gate. The exiting person detection sensor 230 is, for example, a sensor that detects a person by using infrared rays. When the checkout unit 120 recognizes exit of a person from the gate 20, the checkout unit 120 completes the checkout processing on a read product. Subsequently, as described by using FIG. 8, when the coupon use information transmitted from the terminal 30 is acquired, the checkout unit 120 corrects a result of the checkout processing being once completed, based on the coupon use information. For example, the checkout unit 120 withdraws a payment claim that is already transmitted to an institution (for example, a card company, and the like) related to payment of a product price, then computes an amount claimed when a coupon is applied, and transmits again a payment claim based on the amount claimed.

In this way, by completing the checkout processing regardless of whether the coupon use information is acquired, a person who does not intend to use a coupon does not need to take action to notify a system side that the person does not use the coupon. Further, in a case of a configuration in which the store apparatus 10 (computer) waits for acquisition of the coupon use information, and completes the checkout processing, information throughput (processing speed) per unit time of the store apparatus 10 in the checkout processing decreases by holding time until the coupon use information is acquired. According to the configuration described above, holding time until the coupon use information is acquired does not occur at all, and thus an effect of preventing an amount of pieces of information processed per unit time from decreasing (preventing processing speed of a computer from decreasing) can be acquired. Further, according to the configuration described above, an effect of reducing a risk that the checkout processing on hold is accumulated in the store apparatus 10 or an apparatus of a system in cooperation with the store apparatus 10 in the checkout processing and a processing load on the apparatus increases can also be expected.

Further, the checkout unit 120 may wait for acquisition of the coupon use information after the person P exits from the gate 20, and perform the checkout processing. In this case, after the application processing of a coupon indicated by the coupon use information is performed (i.e., in a state where a coupon is applied), the checkout processing is performed. Further, in this case, the checkout unit 120 may be configured to perform the checkout processing without performing the coupon application processing when the checkout unit 120 cannot acquire the coupon use information within a preset period. In this way, a person who does not intend to use a coupon does not need to take action to notify a system side that the person does not use the coupon.

Note that, when the coupon use information is not acquired within a preset period, a possibility that a person who possesses the terminal 30 does not notice notification information, forgets to make a use declaration of a coupon, or the like are conceivable. Thus, the coupon notification unit 110 may be configured to transmit, to the terminal 30, notification that confirms an intention to use an applicable coupon with a customer when the coupon use information is not acquired within a preset period. For example, the coupon notification unit 110 transmits, to the terminal 30, a message notifying again that there is an applicable coupon, and the like at a timing at which a predetermined period elapses since notification information indicating the applicable coupon is transmitted or at a slightly earlier timing. An application installed in the terminal 30 displays a pop-up message and the like in response to notification from the coupon notification unit 110, and notifies a user of the terminal 30 that an applicable coupon is available without being used. In this way, a customer can be prevented from missing an opportunity to use an applicable coupon.

Further, as illustrated in FIG. 5, when the exiting person detection sensor 230 is provided near the exit side of the gate 20, the person determination information acquisition apparatus 210 may be configured to start, in response to detection of a person (first person) who exits from the gate 20 by the exiting person detection sensor 230, processing of acquiring person determination information about a person (second person) who passes through the gate after the first person. As one example, the person determination information acquisition apparatus 210 may be configured to start up a camera module and capture a face image for face authentication when the person determination information acquisition apparatus 210 acquires, from the exiting person detection sensor 230, a signal indicating exit of the first person from the gate 20. In this case, the person determination information acquisition apparatus 210 stops an operation at a timing at which person determination information can be acquired (for example, a face image of a person who passes through the gate 20 can be acquired). In this way, the person determination information acquisition apparatus 210 is configured to operate as necessary, and thus an effect of reducing consumed power of the entire system can be expected.

### Second Example Embodiment

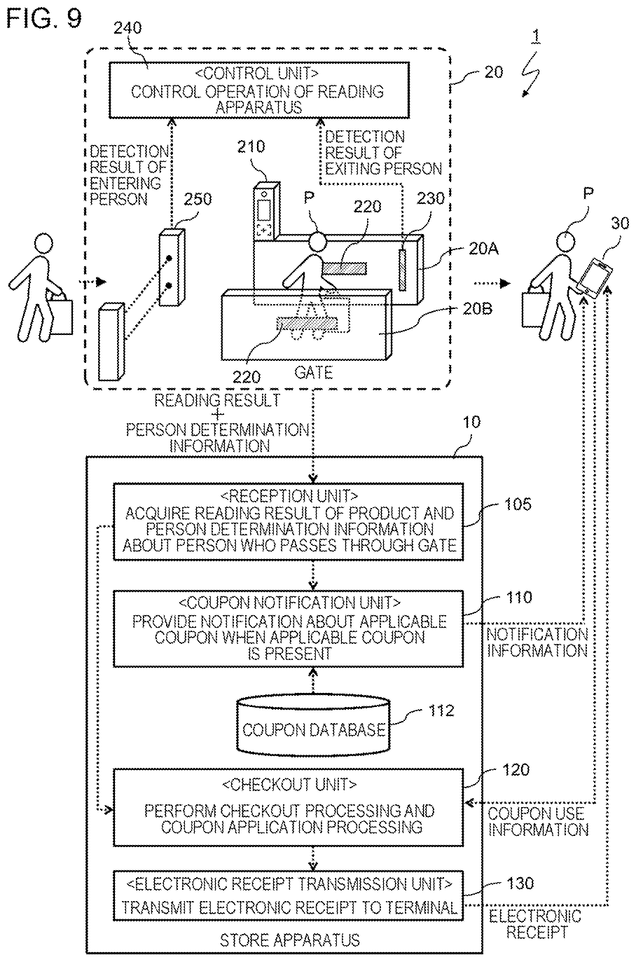

FIG. 9 is a diagram illustrating a configuration of a store system 1 according to a second example embodiment. As illustrated in FIG. 9, the store system 1 according to the present example embodiment is different from the first example embodiment in a point that the store system 1 according to the present example embodiment further includes a control unit 240 for controlling an operation of a reading apparatus 220. The store apparatus 1 according to the present example embodiment has a configuration similar to that in the first example embodiment except for a point described below.

The control unit 240 starts an operation of the reading apparatus 220 when it can be estimated that a certain person will pass a gate 20 in the future, and stops an operation of the reading apparatus 220 when it can be estimated that the person exits from the gate 20. As one example, the control unit 240 starts an operation of the reading apparatus 220 in response to at least either one of (1) acquisition of person determination information about a person who passes through the gate 20 by a person determination information acquisition apparatus 210 and (2) detection of a person by an entering person detection sensor 250 that detects a person who enters the gate 20 when the entering person detection sensor is provided. Further, the control unit 240 stops an operation of the reading apparatus 220 in response to detection of a person who exits from the gate 20 by an exiting person detection sensor 230. The control unit 240 may be configured in such a way as to acquire a video in a vicinity of an entrance of the gate from one or more cameras (for example, surveillance cameras) that capture the vicinity of the entrance of the gate 20, and detect a person who enters the gate 20 and a person who exits from the gate 20 by processing the video.

In the present example embodiment, the reading apparatus 220 is controlled by the control unit 240 in such a way that the reading apparatus 220 performs a reading operation of a product when it is estimated that a person (product) passes through the gate 20, and stops the reading operation of the product when it is estimated that the person exits from the gate 20. In other words, the reading apparatus 220 operates only when it is estimated that the reading operation of a product is needed. In this way, an effect of reducing consumed power of the entire store system 1 can be acquired. Further, when a plurality of the gates 20 are provided side by side, an effect of reducing a possibility that a product that passes through another gate 20 is detected by mistake can also be expected.

### Third Example Embodiment

In the present example embodiment, an application program operating in a terminal 30 used by a customer (user) of a store will be described.

### <Functional Configuration of Application Program>

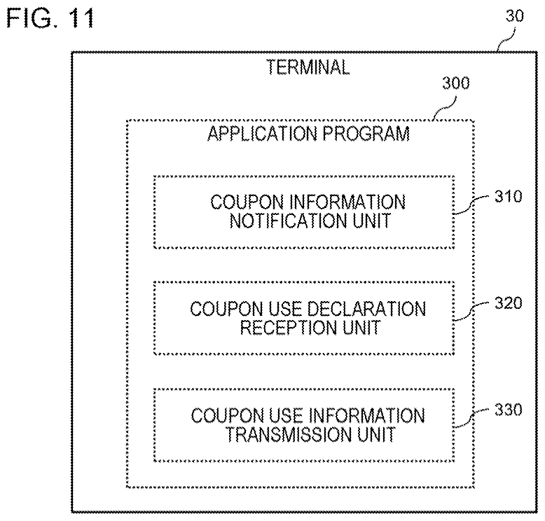

FIG. 11 is a diagram illustrating a functional configuration of the application program. As illustrated in FIG. 11, an application program 300 for functioning as a coupon information notification unit 310, a coupon use declaration reception unit 320, and a coupon use information transmission unit 330 is installed in the terminal 30. The application program 300 is downloaded from a not-illustrated server apparatus to a storage region of the terminal 30. A function of the coupon information notification unit 310, the coupon use declaration reception unit 320, the coupon use information transmission unit 330, and the like is achieved by a processor of the terminal 30 reading the application program 300 onto a memory and executing the read application program 300.

The coupon information notification unit 310 acquires, from a store apparatus 10, notification information that provides notification of a coupon applicable to a product read at a gate 20, and displays a screen including information about the applicable coupon on a display of the terminal 30. The coupon information notification unit 310 displays the screen as illustrated in FIG. 8, for example, on the display of the terminal 30. The coupon use declaration reception unit 320 receives, on the screen displayed on the display of the terminal 30, a use declaration of a coupon (for example: an operation of selecting a coupon to be used) by a user. The coupon use information transmission unit 330 transmits, to a store apparatus 11 (apparatus that performs checkout processing), coupon use information indicating a coupon to be used by a user, based on a use declaration of a coupon by the user.

### <Flow of Processing>

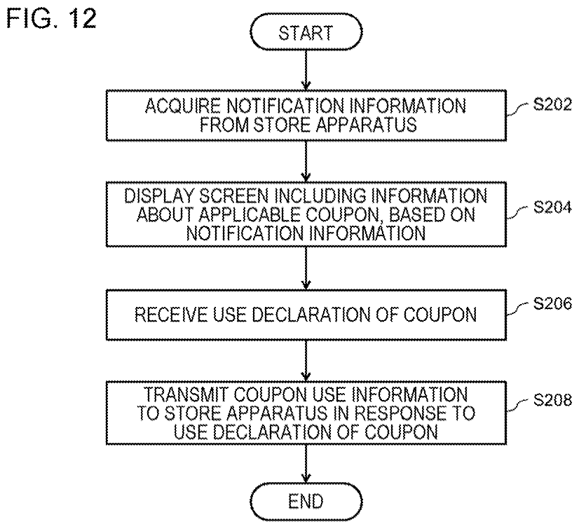

FIG. 12 is a flowchart illustrating a flow of processing performed by the application program 300.

First, the coupon information notification unit 310 acquires notification information (information that provides notification of an applicable coupon) transmitted from the store apparatus 10 (coupon notification unit 110) (S202). The coupon information notification unit 310 displays a screen including information about the applicable coupon on a display unit of the terminal 30, based on the acquired notification information (S204). The coupon information notification unit 310 displays the screen as illustrated in FIG. 8, for example, on the display unit of the terminal 30.

Then, the coupon use declaration reception unit 320 receives, on the screen displayed on the display unit of the terminal 30, a use declaration of a coupon (S206). For example, the coupon use declaration reception unit 320 receives an operation of selecting, on the screen 82 illustrated in FIG. 8, checkout processing targeted for a coupon, and an operation of selecting and confirming, on the screen 84 illustrated in FIG. 8, a coupon to be used.

Then, the coupon use information transmission unit 330 generates information (coupon use information) indicating the coupon to be used by a customer in response to the use declaration of the coupon, and transmits the generated information to the store apparatus 10 (S208). For example, the coupon use information transmission unit 330 acquires information that identifies a selected and confirmed coupon, based on an operation on the screen, and transmits, to the store apparatus 10, the information that identifies the coupon as coupon use information.

As described above, according to the present example embodiment, when a customer passes through the gate 20 with a product, information about a coupon applicable to any read product is transmitted to the customer via the application program 300. Then, when the customer makes a use declaration of the coupon on the application program 300, coupon use information indicating the coupon to be used by the customer is transmitted to the store apparatus 10 in response to the use declaration of the coupon. According to the application program 300 described in the present example embodiment and installed in the terminal 30, in a store system 1 for reading a product that passes through the gate 20 and performing checkout, a customer can easily use a coupon.

While the example embodiments of the present invention have been described above with reference to the drawings, the present invention should not be interpreted by being limited to the example embodiments, and various modifications, improvements, and the like can be made based on knowledge of a person skilled in the art without departing from the scope of the present invention.

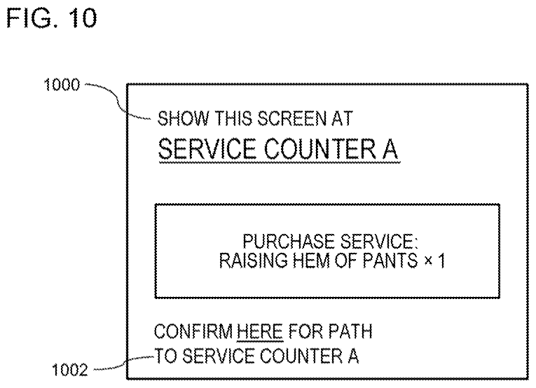

For example, service (intangible product) provided at a store can also be read at the gate by using an RF tag. Specific examples include a case of a clothing store that provides service to raise a hem of pants, service to alter a length of a jacket, and the like. In this case, processing as follows is performed. First, a customer passes through the gate 20 with a card associated with desired service. An RF tag is provided to each card, and a reading apparatus 220 reads information (tag ID) stored in the RF tag provided to the card. Information indicating a correspondence between an RF tag provided to each card and information indicating service is stored in a storage device 1040 of the store apparatus 10, and the store apparatus 10 refers to the information and recognizes service associated with an RF tag read at the gate 20. The store apparatus 10 transmits, to the terminal 30, information (for example: FIG. 10) that guides a customer to a place (for example, a service counter, and the like) where the customer can receive the recognized service. FIG. 10 is a diagram illustrating one example of information that guides a customer to a place where the customer can receive service. FIG. 10 illustrates a screen 1000 including information that notifies a customer of where the customer needs to head for receiving service to raise a hem of pants. A customer can easily recognize a place where the customer can receive desired service by confirming the screen as illustrated in FIG. 10. Further, the screen 1000 may include information (reference sign 1002 in FIG. 10) displaying a map indicating the place where the customer can receive the desired service.

Further, a plurality of components disclosed in the example embodiments can form various inventions by an appropriate combination. For example, some components may be deleted from all the components indicated in the example embodiments, and components in different example embodiments may be appropriately combined.

Further, the plurality of steps (processing) are described in order in the flowcharts used in the above-described description, but an execution order of steps performed in each of the example embodiments is not limited to the described order. In each of the example embodiments, an order of illustrated steps may be changed within an extent that there is not harm in context.

A part or the whole of the above-described example embodiment may also be described in supplementary notes below, which is not limited thereto.

1. A store system, including:
a reading unit that reads a product that passes through a gate;
a person determination information acquisition unit that acquires person determination information that determines a person who passes through the gate;
a coupon notification unit that transmits, when a coupon applicable to any product read by the reading unit is present, notification information that provides notification of the applicable coupon, to a terminal associated with the person determination information;
a checkout unit that performs checkout processing of a product read by the reading unit, and application processing of a coupon based on coupon use information that is acquired from the terminal and indicates a coupon to be used by the person; and
an electronic receipt transmission unit that transmits an electronic receipt to the terminal in response to execution of the checkout processing and the application processing of a coupon.

2. The store system according to supplementary note 1, wherein
the reading unit reads a radio frequency (RF) tag provided to an individual product.

3. The store system according to supplementary note 1 or 2, wherein
the checkout unit performs the application processing of a coupon after the checkout processing is performed.

4. The store system according to supplementary note 3, wherein
the checkout unit performs the checkout processing in response to detection of the person by an exiting person detection sensor that detects a person who exits from the gate.

5. The store system according to supplementary note 1 or 2, wherein
the checkout unit performs the checkout processing after the application processing of a coupon is performed.

6. The store system according to any one of supplementary notes 1 to 5, wherein
the person determination information acquisition unit acquires a face image of the person as the person determination information.

7. The store system according to supplementary note 6, wherein
the person determination information acquisition unit causes a camera that generates the face image to perform a capturing operation in response to detection of the person by an entering person detection sensor that detects a person located in front of the gate.

8. The store system according to any one of supplementary notes 1 to 7, further including
a control unit that controls an operation of the reading unit, wherein
the control unit
   operates the reading unit in response to at least either one of acquisition of the person determination information and detection of the person by an entering person detection sensor that detects a person located in front of the gate, and
   stops an operation of the reading unit in response to detection of the person by an exiting person detection sensor that detects a person who exits from the gate.

9. The store system according to any one of supplementary notes 1 to 8, wherein
the person determination information acquisition unit starts, in response to detection of a first person by an exiting person detection sensor that detects a person who exits from the gate, processing of acquiring person determination information about a second person who passes through the gate after the first person.

10. The store system according to any one of supplementary notes 1 to 9, wherein
the checkout unit performs the checkout processing when the coupon use information cannot be acquired within a preset period.

11. A checkout method being executed by at least one computer, the checkout method including:
reading a product that passes through a gate;
acquiring person determination information that determines a person who passes through the gate;
transmitting, when a coupon applicable to any read product is present, notification information that provides notification of the applicable coupon, to a terminal associated with the person determination information;
performing checkout processing of the read product, and application processing of a coupon based on coupon use information that is acquired from the terminal and indicates a coupon to be used by the person; and
transmitting an electronic receipt to the terminal in response to execution of the checkout processing and the application processing of a coupon.

12. The checkout method according to supplementary note 11, further including, by the computer,
reading a radio frequency (RF) tag provided to an individual product.

13. The checkout method according to supplementary note 11 or 12, further including,
by the computer,
performing the application processing of a coupon after the checkout processing is performed.

14. The checkout method according to supplementary note 13, further including,
by the computer,
performing the checkout processing in response to detection of the person by an exiting person detection sensor that detects a person who exits from the gate.

15. The checkout method according to supplementary note 11 or 12, further including,
by the computer,
performing the checkout processing after the application processing of a coupon is performed.

16. The checkout method according to any one of supplementary notes 11 to 15, further including,
by the computer,
acquiring a face image of the person as the person determination information.

17. The checkout method according to supplementary note 16, further including,
by the computer,
causing a camera that generates the face image to perform a capturing operation in response to detection of the person by an entering person detection sensor that detects a person located in front of the gate.

18. The checkout method according to any one of supplementary notes 11 to 17, further including:
by the computer,
causing the gate to perform a reading operation of a product in response to at least either one of acquisition of the person determination information and detection of the person by an entering person detection sensor that detects a person located in front of the gate; and
stopping a reading operation of a product by the gate in response to detection of the person by an exiting person detection sensor that detects a person who exits from the gate.

19. The checkout method according to any one of supplementary notes 11 to 18, further including,
by the computer,
starting, in response to detection of a first person by an exiting person detection sensor that detects a person who exits from the gate, processing of acquiring person determination information about a second person who passes through the gate after the first person.

20. The checkout method according to any one of supplementary notes 11 to 19, further including,
by the computer,
performing the checkout processing when the coupon use information cannot be acquired within a preset period.

21. A program for causing at least one computer to function as:
a reading unit that reads a product that passes through a gate;
a person determination information acquisition unit that acquires person determination information that determines a person who passes through the gate;
a coupon notification unit that transmits, when a coupon applicable to any product read by the reading unit is present, notification information that provides notification of the applicable coupon, to a terminal associated with the person determination information;
a checkout unit that performs checkout processing of a product read by the reading unit, and application processing of a coupon based on coupon use information that is acquired from the terminal and indicates a coupon to be used by the person; and
an electronic receipt transmission unit that transmits an electronic receipt to the terminal in response to execution of the checkout processing and the application processing of a coupon.

22. The program according to supplementary note 21, further causing the computer to function as
a unit that reads a radio frequency (RF) tag provided to an individual product.

23. The program according to supplementary note 21 or 22, further causing the computer to function as
a unit that performs the application processing of a coupon after the checkout processing is performed.

24. The program according to supplementary note 23, further causing the computer to function as
a unit that performs the checkout processing in response to detection of the person by an exiting person detection sensor that detects a person who exits from the gate.

25. The program according to supplementary note 21 or 22, further causing the computer to function as
a unit that performs the checkout processing after the application processing of a coupon is performed.

26. The program according to any one of supplementary notes 21 or 25, further causing the computer to function as
a unit that acquires a face image of the person as the person determination information.

27. The program according to supplementary note 26, further causing the computer to function as
a unit that causes a camera that generates the face image to perform a capturing operation in response to detection of the person by an entering person detection sensor that detects a person located in front of the gate.

28. The program according to any one of supplementary notes 21 to 27, further causing the computer to function as
a unit that operates the reading unit in response to at least either one of acquisition of the person determination information and detection of the person by an entering person detection sensor that detects a person located in front of the gate, and
a unit that stops an operation of the reading unit in response to detection of the person by an exiting person detection sensor that detects a person who exits from the gate.

29. The program according to any one of supplementary notes 21 to 28, further causing the computer to function as
a unit that starts, in response to detection of a first person by an exiting person detection sensor that detects a person who exits from the gate, processing of acquiring person determination information about a second person who passes through the gate after the first person.

30. The program according to any one of supplementary notes 21 to 29, further causing the computer to function as
a unit that performs the checkout processing when the coupon use information cannot be acquired within a preset period.

31. A store apparatus, including:
a person determination information reception unit that receives person determination information that determines a user who passes through a gate;
a coupon notification unit that transmits, when a coupon applicable to any read product is present, coupon information about the applicable coupon to a terminal of the user determined by the person determination information; and
a checkout unit that performs, when coupon information indicating a coupon being selected by the user is received from the terminal, checkout processing of the read product, based on the coupon information.

32. A checkout method, including:
by a computer,
receiving person determination information that determines a user who passes through a gate;
transmitting, when a coupon applicable to any read product is present, coupon information about the applicable coupon to a terminal of the user determined by the person determination information; and
performing, when coupon information indicating a coupon being selected by the user is received from the terminal, checkout processing of the read product, based on the coupon information.

33. A program for causing a computer to function as:
a person determination information reception unit that receives person determination information that determines a user who passes through a gate;
a coupon notification unit that transmits, when a coupon applicable to any read product is present, coupon information about the applicable coupon to a terminal of the user determined by the person determination information; and
a checkout unit that performs, when coupon information indicating a coupon being selected by the user is received from the terminal, checkout processing of the read product, based on the coupon information.

34. A program for causing a computer to function as:
a coupon information notification unit that acquires notification information indicating a coupon applicable to a product being read at a gate, and displays a screen including information about the applicable coupon;
a coupon use declaration reception unit that receives, on the screen, a use declaration of a coupon; and
a coupon use information transmission unit that transmits, in response to the use declaration of a coupon, coupon use information indicating a coupon to be used to a store apparatus that performs checkout processing.

This application is based upon and claims the benefit of priority from Japanese patent application No. 2019-038666, filed on Mar. 4, 2019, the disclosure of which is incorporated herein in its entirety by reference.

1. A store apparatus, comprising:
a memory storing instructions; and
a processor configured to execute the instructions to:
receive person determination information that determines a user who passes through a gate;
transmit, when a coupon applicable to any read product is present, coupon information about the applicable coupon to a terminal of the user determined by the person determination information; and
transmit again that there is the applicable coupon, at a timing at which a predetermined period elapses since notification information indicating the applicable coupon is transmitted.

2. The store apparatus according to claim 1, wherein the processor is further configured to execute the instructions to:
perform checkout processing of the read product, and application processing of a coupon based on coupon use information that is acquired from the terminal and indicates a coupon to be used by the person; and
transmit an electronic receipt to the terminal in response to execution of the checkout processing and the application processing of a coupon.

3. The store apparatus according to claim 1, wherein
the read product is read by a radio frequency (RF) tag provided to an individual product.

4. The store apparatus according to claim 1, wherein
the person determination information is a face image of the person.

5. A checkout method being executed by at least one computer, the checkout method comprising:
receiving person determination information that determines a user who passes through a gate;
transmitting, when a coupon applicable to any read product is present, coupon information about the applicable coupon to a terminal of the user determined by the person determination information; and
transmitting again that there is the applicable coupon, at a timing at which a predetermined period elapses since notification information indicating the applicable coupon is transmitted.

6. The checkout method according to claim 5, wherein the checkout method further comprises:
performing checkout processing of the read product, and application processing of a coupon based on coupon use information that is acquired from the terminal and indicates a coupon to be used by the person; and
transmitting an electronic receipt to the terminal in response to execution of the checkout processing and the application processing of a coupon.

7. The checkout method according to claim 5, wherein
the read product is read by a radio frequency (RF) tag provided to an individual product.

8. The checkout method according to claim 5, wherein
the person determination information is a face image of the person.

9. A non-transitory computer-readable medium storing a program for causing at least one computer to perform operations, the operations comprising:
receiving person determination information that determines a user who passes through a gate;
transmitting, when a coupon applicable to any read product is present, coupon information about the applicable coupon to a terminal of the user determined by the person determination information; and
transmitting again that there is the applicable coupon, at a timing at which a predetermined period elapses since notification information indicating the applicable coupon is transmitted.

10. The non-transitory computer-readable medium according to claim 9, wherein the operations further comprise:
performing checkout processing of the read product, and application processing of a coupon based on coupon use information that is acquired from the terminal and indicates a coupon to be used by the person; and
transmitting an electronic receipt to the terminal in response to execution of the checkout processing and the application processing of a coupon.

11. The non-transitory computer-readable medium according to claim 9, wherein
the read product is read by a radio frequency (RF) tag provided to an individual product.

12. The non-transitory computer-readable medium according to claim 9, wherein
the person determination information is a face image of the person.
